(19) United States
(12) Patent Application Publication
(10) Pub. No.: US 2005/0277313 A1
(43) Pub. Date: Dec. 15, 2005

(54) Surface mountable pin assembly for a printed circuit board

(76) Inventor: Aldrin Pangilinan, Manchester, NH (US)

Correspondence Address: NIXON PEABODY, LLP, 401 9TH STREET, NW, SUITE 900, WASHINGTON, DC, 20004-2128, US

(21) Appl. No.: 10/865,718

(22) Filed: Jun. 9, 2004

(51) Int. Cl. H01R 12/00

(52) U.S. Cl. 439/83

(57) ABSTRACT

A surface mount technology (SMT) pin assembly for electrically and mechanically connecting a plurality of co-planar contact areas on the surface of a first printed circuit board (PCB) to a corresponding plurality of co-planar contact areas on the surface of a second PCB is described and comprises a plurality of SMT pins each having first and second opposing sides of approximately equal contact area for attaching to corresponding respective contact areas on the surfaces of adjacent PCBs, and a fixture for retaining said SMT pins in a fixed position relative to each other such that each of said first sides are co-planar and each of said second sides are co-planar. The pin assembly preferably includes either three or five SMT pins. One or more alignment pins are preferably formed on the fixture for enabling insertion into corresponding holes in a PCB to aid in the alignment of the fixture and SMT pins on the surface of the PCB during manufacture.

### FIELD OF THE INVENTION

The present invention relates to printed circuit board (PCB) assemblies and, in particular, to an SMT pin assembly for a PCB.

### BACKGROUND OF THE INVENTION

Computers and other electronic devices often include a plurality of interconnected printed circuit boards (PCBs). For example, it is common for a computer to have a motherboard and one or more other boards that execute or perform specialized operations or tasks, such as power conversion, for providing high current power to the motherboard. Connections between such PCBs allow for the transfer of power between boards, and/or for the transfer of information, such as data or control signals. Printed circuit boards can be connected together through use of high current conductor pins mounted or formed on the edges of the PCBs, by mounting cable or ribbon connectors on each board, or by providing pads on pairs of boards to allow for direct board-to-board connection with surface mount technology (SMT) connector terminals or pins. See, e.g., U.S. patent application Ser. No. 10/634,332, which is incorporated herein by reference.

For board-to-board PCB mounting, it is important that the boards are physically separated as well as electrically connected. It is also important that the boards be mechanically supported to prevent excessive movement of the boards. SMT pins are commonly used to provide these electrical and physical functions. SMT pins of this type are commonly formed of a thin metal sheet bent into a 4-sided, thin-walled structure, where the four sides form a rectangle or similar structure. The resulting hollow structure has one pair of opposing sides (“attachment sides”) that have approximately equal contact areas for attaching to respective co-planar surfaces of the PCBs. The other pair of opposing sides provide electrical connections between the attachment sides of the SMT pins and physical support for the board-to-board PCB mounting.

A key problem with such structures is that these modules typically experience multiple solder reflow processes, not only during initial construction, but also during other assembly steps by the end user. Prior art surface mount technology (SMT) pins tend to shift into misaligned positions or even fall off the PCB as a consequence of undergoing solder reflow, especially during rework procedures. Once an SMT pin falls off, re-installation is very difficult, if not impossible. In other words, each SMT pin is fully dependent on the solder bond that exists between the SMT pin and the PCB pad on which the SMT pin is mounted. A detached or damaged pin makes the entire board nonfunctional.

What is needed is an improved technique for attaching SMT pins to a PCB that solves the above described problems by ensuring that the SMT pins retain their desired alignment on the PCB and co-planarity during initial manufacture of the PCB and later during reflow or rework of the PCB and the attachment of the PCB to the motherboard or other PCB by the end user.

### SUMMARY OF THE INVENTION

The present invention solves the above-identified problems of prior art assembly of SMT pins on PCB's by providing an assembly containing a plurality of SMT pins held in place by a fixture preferably formed from molded plastic having good thermal resistance.

Broadly stated, the present invention is a surface mount technology (SMT) pin assembly for electrically and mechanically connecting a plurality of co-planar contact areas on the surface of a first printed circuit board (PCB) to a corresponding plurality of co-planar contact areas on the surface of a second PCB. The pin assembly comprises a plurality of SMT pins each having first and second opposing sides of approximately equal contact area for attaching to corresponding respective contact areas on the surfaces of adjacent PCBs, and a fixture for retaining said SMT pins in a position where each of said first sides are co-planar and where each of said second sides are co-planar.

Consequently, an advantage of the present invention is that it provides for easy control of the placement of a plurality of SMT pins on a PCB in a desired x, y alignment on the surface of the PCB.

Yet another advantage of the present invention is that one or more alignment pins may be formed on the fixture to further ensure correct placement and installation of the SMT pins in both the x and y directions on the surface of a PCB.

Another advantage of the present invention is that it enables the SMT pins to retain respective co-planarity of their bottom and top surfaces, thereby ensuring that these surfaces are co-planar with contact areas on adjacent PCB surfaces during manufacture.

Yet another advantage of the present invention is that it protects against damage to the bond between each SMT pin and its adjacent PCB contact area during rework conditions because of the thermal protective characteristics of the molded plastic fixture in which the SMT pins are retained.

Another advantage of the present invention is that it enables a plurality of SMT pins to be positioned on a PCB board in a single step.

A further advantage of the present invention is that it provides considerable savings in costs of material, packaging, and assembly.

### BRIEF DESCRIPTION OF THE DRAWINGS

The foregoing aspects and the attendant advantages of the present invention will become more readily appreciated by reference to the following detailed description, when taken in conjunction with the accompanying drawings, wherein:

FIG. 1 shows a perspective view of an SMT pin assembly having five pins according to one embodiment of the present invention;

FIG. 2 is a top view of the SMT pin assembly of FIG. 1;

FIG. 3 is a side view of the SMT pin assembly of FIG. 1;

FIG. 4 is a bottom view of the SMT pin assembly of FIG. 1;

FIG. 5 is an end view of the SMT pin assembly of FIG. 1;

FIGS. 6A and 6B are front and side views of an SMT pin according to the present invention;

FIG. 7 is a top view of an exemplary PCB having contact surfaces and alignment holes sized to enable fastening of respective three and five SMT pin assemblies thereon;

FIG. 8 is an exploded perspective view of two SMT pin assemblies and an exemplary PCB;

FIG. 9 is a perspective view of the PCB of FIG. 8 wherein said SMT pin assemblies are mounted on the surface of said PCB; and

FIG. 10 is a side view of two PCBs interconnected by two SMT pin assemblies according to the present invention.

Reference symbols are used in the figures to indicate certain components, aspects or features shown therein, with reference symbols common to more than one figure indicating like components, aspects or features shown therein.

### DETAILED DESCRIPTION OF THE INVENTION

To facilitate its description, the present invention is described below in terms of an SMT pin assembly for providing a connection between two PCBs. In the example described below, the first PCB is a DC-DC power converter module and the second PCB is a computer motherboard. In general, the present invention is a device for providing connection between two printed circuit boards using surface mount technologies, and should therefore not be taken as limited except as provided in the attached claims.

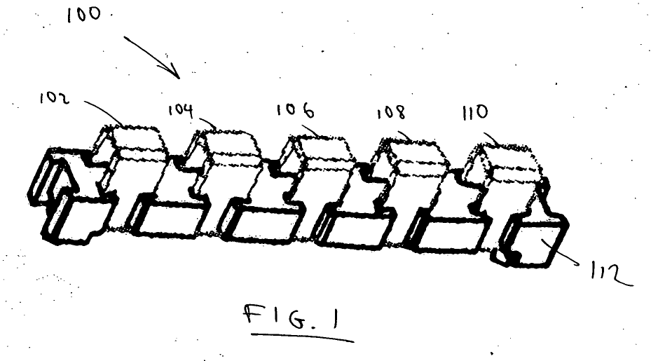

The present invention will now be described in more detail with reference to the figures. FIG. 1 shows a perspective view of an SMT pin assembly 100 according to one embodiment of the present invention. Pin assembly 100 includes five SMT pins, shown at 102, 104, 106, 108 and 110.

The SMT pins are made of a highly conductive metal, such as copper, though other conductors, such as metals or alloys may be used. The material and dimensions of each SMT pin is selected for each application to provide for adequate conductive heat transfer and electrical current capacity from one board to the other, such as from a heat generating DC-DC converter module to a motherboard. The SMT pins also preferably provide mechanical support for the PCBs. An exemplary SMT pin is shown in front and side views in FIGS. 6A and 6B. A typical size for an SMT pin is about 0.3 mm in thickness and a width of approximately 2.6 mm.

Pins 102-110 are retained in place by a fixture 112 that is preferably made of a high temperature resistant insulating plastic that is molded into the shape needed in a given application. According to one embodiment, the insulating material is a liquid crystal polymer that is well suited for applications where there are difficult to fill in geometries. Fixtures formed from such material also have a good resistance to warping, are compatible with IR reflow environments, and have a good thermal resistance for surface mount interconnection devices. The high temperature resistance of the fixture 112 enables it to serve as a heat shield for SMT pin solder joints during any solder reflow manufacturing process. In other words, the insulating material serves to keep the solder joint between the pins and the corresponding contact areas on an adjacent PCB from wetting during rework, thereby minimizing the possibility that any of the SMT pins will work loose from secure solder contact with the adjacent PCB.

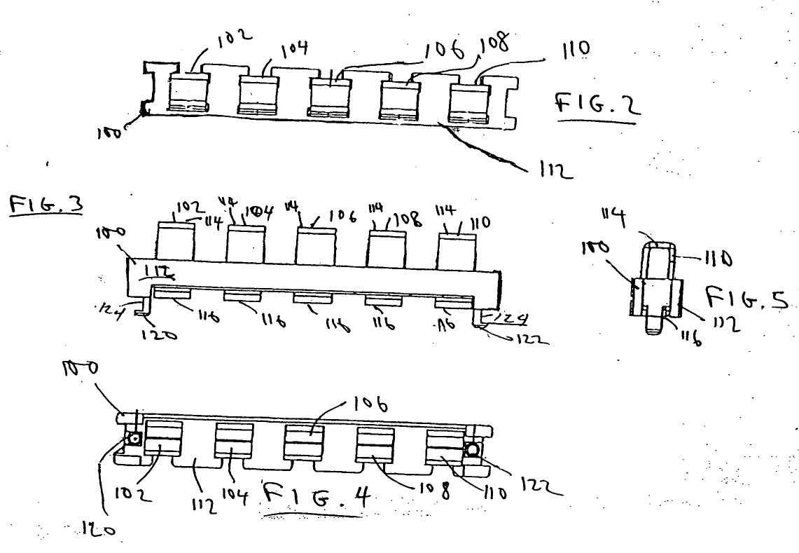

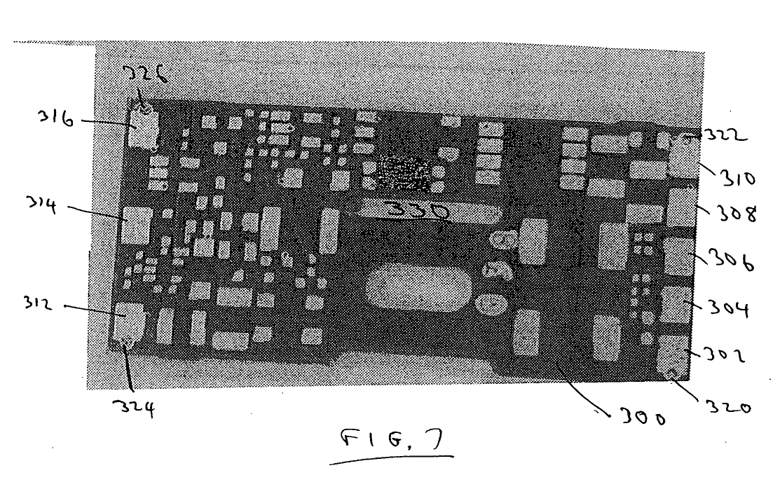

FIGS. 2 through 5 show top, side, bottom and end views of the SMT pin assembly 100 of FIG. 1. As can be seen, fixture 112 retains each SMT pin 102-110 in an aligned position with respect to each other. Each SMT pin has first and second opposing sides 114 and 116 of approximately equal contact area for attaching to corresponding respective contact areas on the surfaces of adjacent PCBs. Fixture 112 retains SMT pins 102-110 in a position where each of said first sides 114 are co-planar and where each of said second sides 116 are co-planar.

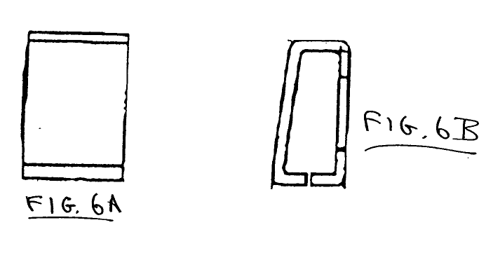

The present invention preferably also includes one or more alignment pins, e.g., alignment pins 120 and 122 shown in FIGS. 3 and 4, formed on the fixture to further ensure proper x and y direction placement and installation of the SMT pins on the surface of a PCB. Each alignment pin 120, 122 is positioned on the fixture at a predetermined point to enable insertion of the alignment pin in an alignment hole formed in the PCB, to thereby correctly orient the SMT pins 102-110 and fixture 112 at a predetermined x-y position on the PCB. Each alignment pin preferably also includes a cutout 124 formed therein, as best seen in FIG. 3, to provide a space that can be filled with a fastening material, such as solder or epoxy, during assembly of the pin assembly 100 to the PCB, to secure pin assembly 100 to the PCB.

FIG. 7 is a top view of an exemplary PCB 300 having contact surfaces and alignment holes formed on surface 330 that are sized to enable positioning of respective three and five SMT pin assemblies thereon for soldering. A plurality of co-planar contact areas are formed on the surface of PCB 300 at 302, 304, 306, 308, 310, 312, 314, and 316. A five pin SMT pin assembly, such as the assembly 100 shown in FIGS. 1-5, can be soldered to contact areas 302-310, i.e., the side 116 of pin 102 is soldered to PCB contact area 302, the side 116 of pin 104 soldered to contact area 304, etc. Holes 320, 322, 324, and 326 are preferably also formed in PCB 300, as shown, to provide correct x and y positioning for respective five and three pin SMT pin assemblies on the surface of PCB 300. That is, for a five pin SMT pin assembly 100 that is intended to be mounted on a PCB 300 for a DC-DC converter, for example, the alignment pins 120 and 122, best shown in FIG. 3, are inserted either manually or automatically during assembly of the DC-DC converter into corresponding holes 320 and 322 in PCB 300, to accurately position SMT pin assembly 100 on the surface of PCB 300. Holes 324 and 326 are similarly preferably used to accurately position a three pin SMT assembly with respect to contact areas 312-316 on PCB 300. As is seen, during this assembly process, there is no need for expensive tape and reel packaging of individual SMT pins.

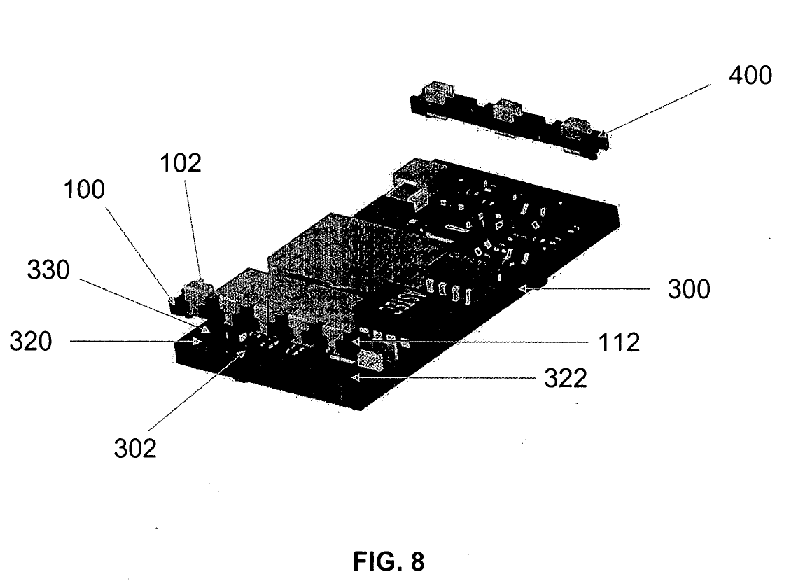

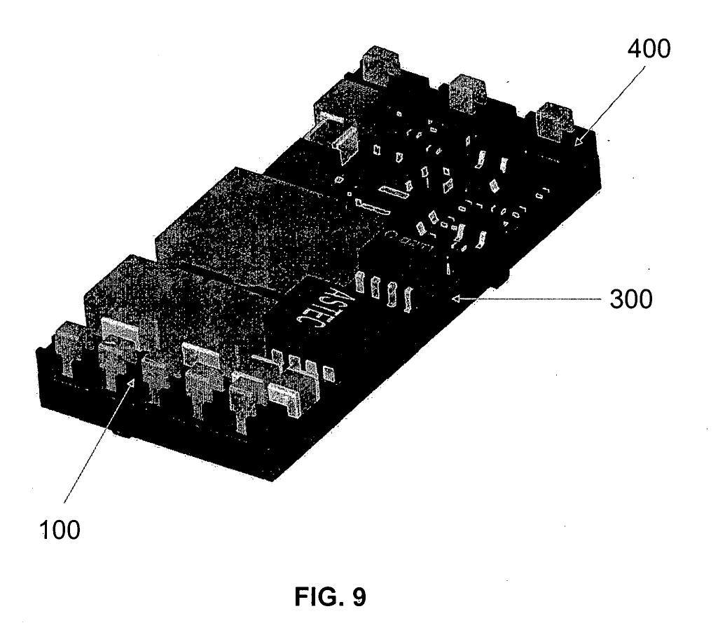

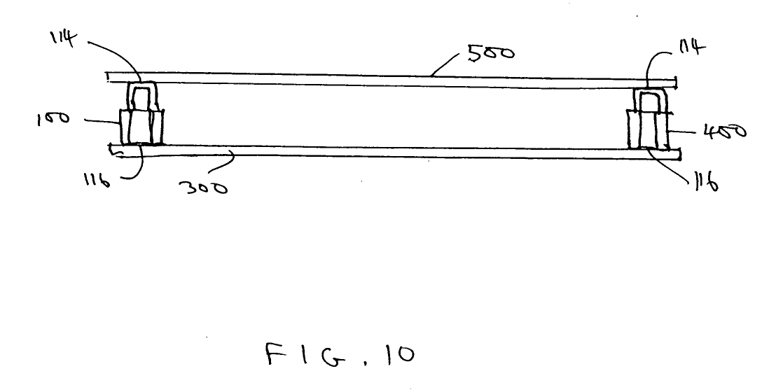

FIG. 8 is an exploded perspective view of two SMT pin assemblies, the exemplary five pin SMT pin assembly 100, described above, and a three pin SMT pin assembly 400, positioned for fastening on PCB 300. FIG. 9 is a perspective view of PCB 300 and illustrates SMT pin assemblies 100 and 400 mounted on the surface of PCB 300. As is seen, for example, SMT pin 102 is retained in place by fixture 112 ready for fastening of its second opposing side 116 to contact area 302 on the surface 330 of PCB 300. The other SMT pins in fixture 112 are also ready to be fastened on their respective corresponding contact areas on PCB 300. Holes 320 and 322 formed in PCB 300 enable corresponding alignment pins 120 and 122 (not shown) on fixture 112 to be inserted therein.

FIG. 10 is a side view of two PCBs interconnected by two SMT pin assemblies according to the present invention. As is seen, PCB 300 includes SMT pin assemblies 100 and 400 mounted thereon, as described above. Pin assemblies 100 and 400 enable a user to fasten the first opposing sides 114 of each SMT pin 102, et al., to corresponding contact areas on PCB 500, which may comprise a user's motherboard, as described above. Thus, opposing sides 114 and 116 of each SMT pin are co-planar with corresponding sides of the other SMT pins in each pin assembly 100, 400 and enable electrical contact between contact areas on PCB 300, via side 116, and corresponding contact areas on PCB 500, via side 114. In other words, in FIG. 10, side 116 is the bottom co-planar surface of each SMT pin and is designed to be soldered to corresponding contact areas on PCB 300, and side 114 is the top co-planar surface of each SMT pin and is designed to be soldered to corresponding contact areas on PCB 500.

Note that, in a preferred embodiment, opposing sides 114 and 116 on each pin define parallel surfaces, thereby enabling the mounting of two PCBs in a parallel orientation. However, this is not required according to the present invention. Opposing sides 114 and 116 can define non-parallel surfaces where the two adjacent PCBs are designed to be in an orientation that is not parallel.

The invention has now been explained with regard to specific embodiments. Variations on these embodiments and other embodiments may be apparent to those of skill in the art. It is therefore intended that the invention not be limited by the discussion of specific embodiments. It is understood that the examples and embodiments described herein are for illustrative purposes only and that various modifications or changes in light thereof will be suggested to persons skilled in the art and are to be included within the scope of the appended claims.

1. A surface mount technology (SMT) pin assembly for connecting a plurality of co-planar contact areas on the surface of a first printed circuit board (PCB) to a corresponding plurality of co-planar contact areas on the surface of a second printed circuit board (PCB), said pin assembly comprising:
a plurality of SMT pins each having first and second opposing sides of approximately equal contact area for attaching to corresponding respective contact areas on the surfaces of adjacent PCBs; and
a fixture for retaining said SMT pins in a position where each of said first sides are co-planar and where each of said second sides are co-planar.

2. The pin assembly of claim 1, wherein said fixture includes at least one alignment pin positioned on the fixture at a predetermined point to enable insertion of the alignment pin in an alignment hole formed in one of said PCBs, to thereby orient said plurality of SMT pins and said fixture at a predetermined x-y position on the surface of said PCB.

3. The pin assembly of claim 2, wherein said fixture includes two spaced apart alignment pins and wherein each said alignment pin includes a cutout formed therein to provide space that can be filled with a fastening material during assembly.

4. The pin assembly of claim 1, wherein said fixture is formed using high temperature resistant molded plastic.

5. The pin assembly of claim 1, wherein said fixture is formed using a liquid crystal polymer.

6. The pin assembly of claim 1, wherein each SMT pin is a highly conductive metal and has a hollow cross-section.

7. The assembly of claim 1, wherein the contact area on the first side of each said SMT pin is parallel to the contact area on the second side of said PMT pin.

8. The pin assembly of claim 1, wherein three SMT pins are retained by the fixture.

9. The pin assembly of claim 1, wherein five SMT pins are retained by the fixture.

10. The pin assembly of claim 1, wherein said SMT pin assembly provides both electrical connections and mechanical support for adjacent PCBs when fastened thereto.

11. A surface mount technology (SMT) pin assembly for connecting a plurality of co-planar contact areas on the surface of a first printed circuit board (PCB) to a corresponding plurality of co-planar contact areas on the surface of a second printed circuit board (PCB), said pin assembly comprising:
a plurality of SMT pins each having first and second opposing sides of approximately equal contact area to enable said pins to be attached to corresponding respective contact areas on the surfaces of adjacent PCBs; and
a fixture for holding said SMT pins in a co-planar and aligned position, wherein each said SMT pin bottom surface is co-planar with each of the other SMT pin bottom surfaces, wherein each said SMT top surface is co-planar with each of the other SMT pin top surfaces, and wherein each said SMT pin is maintained in a predetermined x, y position relative to each of the other SMT pins.
